(19) United States
(12) Patent Application Publication
(10) Pub. No.: US 2012/0251842 A1
(43) Pub. Date: Oct. 4, 2012

(54) LOW ROUGHNESS HEATSINK DESIGN FOR HEAT ASSISTED MAGNETIC RECORDING MEDIA

(75) Inventors: Hua Yuan, Milpitas, CA (US); Alexander Chernyshov, San Jose, CA (US); Gerardo A. Bertero, Redwood City, CA (US); B. Ramamurthy Acharya, Fremont, CA (US)

(73) Assignee: WD Media, Inc., San Jose, CA (US)

(21) Appl. No.: 13/077,160

(22) Filed: Mar. 31, 2011

(51) Int. Cl. B05D 5/12; C21D 1/68; G11B 5/33; B01J 19/08

(52) U.S. Cl. 428/800; 427/127; 427/457; 427/130; 148/537

(57) ABSTRACT

A magnetic recording medium comprises a substrate; a heatsink layer comprising a layer of crystallized CuTi; and a hard magnetic recording layer. The crystallized CuTi is applied in an amorphous state and then crystallized through heating. The use of this heatsink improves surface and underlayer roughness compared to previous heatsink designs.

### TECHNICAL FIELD

This invention relates to the field of disk drives and more specifically, to heatsink layers for heat or energy assisted magnetic recording media.

### BACKGROUND

Energy assisted or heat assisted magnetic recording (HAMR) exploits the drop in a magnetic medium's coercivity when the disk's temperature is raised to near the Curie level. This allows use of magnetic media with high room-temperature coercivities by heating the media prior to the write operation. The heat introduced during this process must be dissipated to avoid heat spread, which could destabilize adjacent information, and destabilize the present information as the media cools.

To achieve low flying height for magnetic heads and good recording reliability, low roughness media are desired. In HAMR media, the heatsink layer contributes to the roughness of the overall media. Additionally, when heated, typical heatsink layers increase in roughness, limiting the temperatures that may be used during HAMR recording.

### BRIEF DESCRIPTION OF THE DRAWINGS

The present invention is illustrated by way of example, and not limitation, in the figures of the accompanying drawings in which:

FIG. 1 is a method of manufacturing HAMR media;

FIG. 2 illustrates a HAMR medium at various stages in the method of FIG. 1;

FIG. 3A illustrates a first HAMR medium configuration;

FIG. 3B illustrates a second HAMR medium configuration;

FIG. 3C illustrates a third HAMR medium configuration;

FIG. 4A is a TEM of a prior art HAMR medium with a CuZr heatsink;

FIG. 4B is a TEM of a HAMR medium employing a CuTi heatsink;

FIG. 5 is a method of manufacturing HAMR media using voltage biasing during the heatsink deposition phase;

FIG. 6 is a HAMR medium employing a dual-layer heatsink of CuTi and CuZr; and

FIG. 7 illustrates experimental roughness results of varying thicknesses of CuZr in a dual-layer heatsink.

### DETAILED DESCRIPTION

In the following description, numerous specific details are set forth, such as examples of specific layer compositions and properties, to provide a thorough understanding of various embodiment of the present invention. It will be apparent however, to one skilled in the art that these specific details need not be employed to practice various embodiments of the present invention. In other instances, well known components or methods have not been described in detail to avoid unnecessarily obscuring various embodiments of the present invention.

The terms “over,” “under,” “between,” and “on” as used herein refer to a relative position of one media layer with respect to other layers. As such, for example, one layer disposed over or under another layer may be directly in contact with the other layer or may have one or more intervening layers. Moreover, one layer disposed between two layers may be directly in contact with the two layers or may have one or more intervening layers. In contrast, a first layer “on” a second layer is in contact with that second layer. Additionally, the relative position of one layer with respect to other layers is provided assuming operations are performed relative to a substrate without consideration of the absolute orientation of the substrate.

Embodiments of the present invention relate to heatsink layers for HAMR media that contribute low roughness to the media while maintaining reasonable thermal conductivity. In some embodiments, a HAMR media (HAMR) comprises a hard magnetic recording layer (L1₀ FePt), a soft magnetic underlayer (SUL), a heatsink layer and a non-magnetic interlayer between the hard magnetic recording layer and SUL. In some embodiments, an amorphous CuTi film is deposited at room temperature, then heated up to high temperature ranging from 350° C. to 650° C. After heating, CuTi crystallizes and its thermal conductivity increases from 1 W/mK to 10 W/mK or higher. In further embodiments a dual CuTi/CuZr or CuTi/Cu heatsink may be employed, where the thermal barrier resistance greatly decreases and thermal conductivities will be further improved without roughness increase.

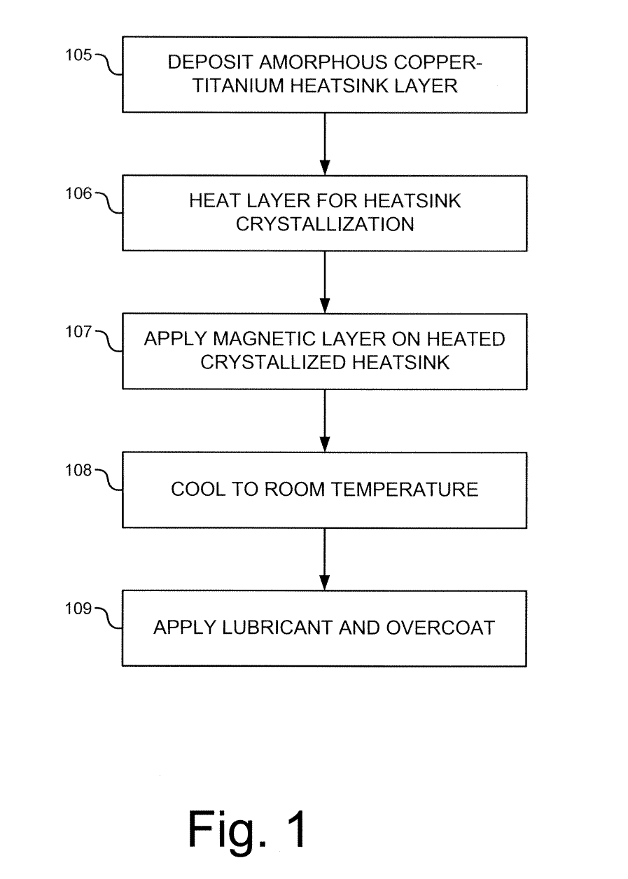

FIG. 1 illustrates a method for manufacturing a HAMR media having a low-roughness heatsink in accordance with an embodiment of the invention. In step 105, a layer of an amorphous heatsink material is deposited on a base layer over a substrate. The amorphous heatsink material may comprise an amorphous CuTi film deposited in a room-temperature sputtering process. In further embodiments, a layer of CuZr may be deposited on the CuTl layer to form a dual-layer heatsink layer. The base layer may comprise an adhesion layer, a crystal seed layer, a soft magnetic underlayer (SUL), or the media substrate. Additionally, any other amorphous media layers may be deposited during step 105. For example, in some embodiments, an amorphous interlayer, such as a layer of CrTa, CoCrTaZr, CoTaZr, or CrTi, may be deposited on the amorphous CuTi layer. In further embodiments, an amorphous SUL, such as a layer of CoFeTaZr, may be deposited on the amorphous CuTi layer, with the amorphous interlayer deposited on the SUL. The layers deposited before step 106 may be referred to as the underlayer.

In step 106, the underlayer is heated to a temperature sufficient to crystallize the CuTi layer. Upon crystallization, CuTi's head conductivity improves, for example, from about 1 W/mK to about 10 W/mK. In some embodiments, the temperature sufficient to crystallize the CutTi layer is between about 350° C. and 650° C. In step 107, a magnetic layer is deposited over the heated, crystallized, CuTi layer. In some embodiments, this comprises depositing the magnetic layer on the underlayer. In further embodiments, a crystal seed layer, such as a thin layer of MgO may be deposited on the underlayer and under the magnetic layer. In some embodiments, the magnetic layer comprises a L1₀ phase FePt recording layer. In these embodiments, the equiatomic FePt forms an ordered, intermetallic L1 phase under the high temperature deposition conditions presented by the heated underlayer. L1₀ FePt has a relatively high magnetic moment and magnetocrystalline anisotropy Kᵤ, making it useful as a high areal density magnetic recording layer. In further embodiments, the hard magnetic layer may comprises one or more additives such as Ag, Au, Cu, Ni, B, oxides, carbon, nitrides, or carbides (FePt:X). In a particular embodiment, the hard magnetic layer comprises one or more layers of FePt:C, with varying ratios of FePt and C. In still further embodiments, a capping layer, which is magnetically softer than the hard magnetic layer and improves the switching field distribution, may be applied to the hard magnetic layer. Such capping layers include layers of FePt, CoPt, or alloys of FePt or CoPt with additives such as Ag, Au, Ni, Cu, B. In some embodiments, the capping is applied at a temperature below the ordering temperature for the material making up the capping layer. In these embodiments, the capping layer has an ordering temperature higher than the ordering temperature of the hard magnetic layer, and the CuTi layer is heated to a temperature below the ordering temperature of the capping layer but above the ordering temperature of the hard magnetic layer.

In step 108, the assembly with the applied magnetic layer is cooled to room temperature. In various embodiments, the rate of cooling may be controlled. For example, between 10° C./sec and 200° C./sec. After the assembly is cooled, in step 109, overcoat and lubricant layers may be applied. For example, a first layer of C may be deposited using chemical vapor deposition (CVD) to form a protective overcoat layer and a layer of flash-deposited C may be applied to form a lubricant layer.

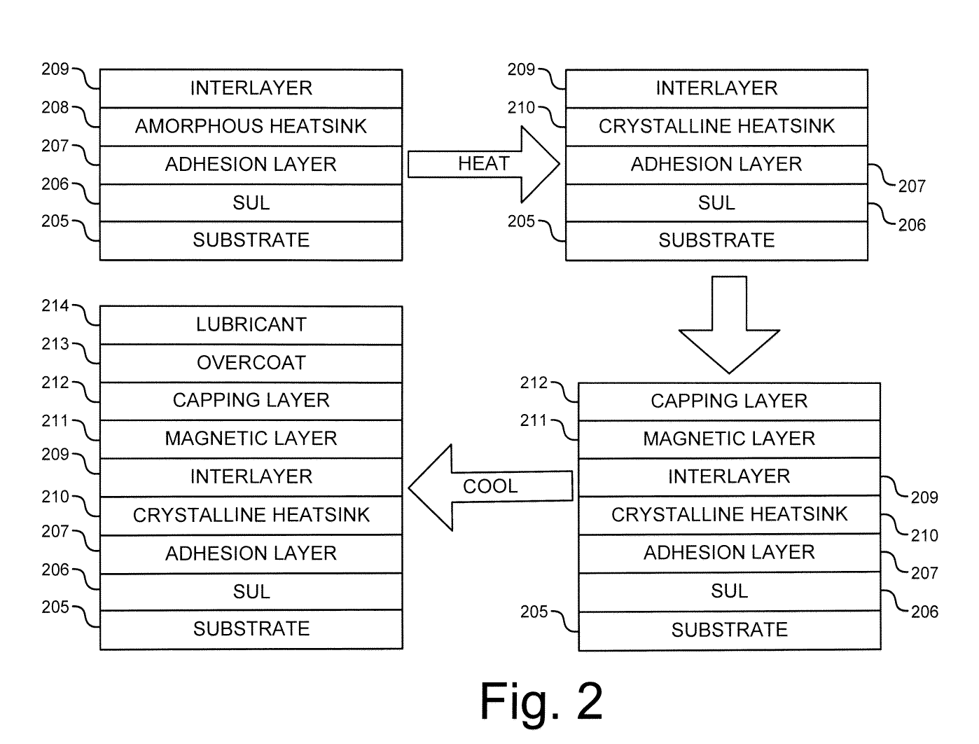

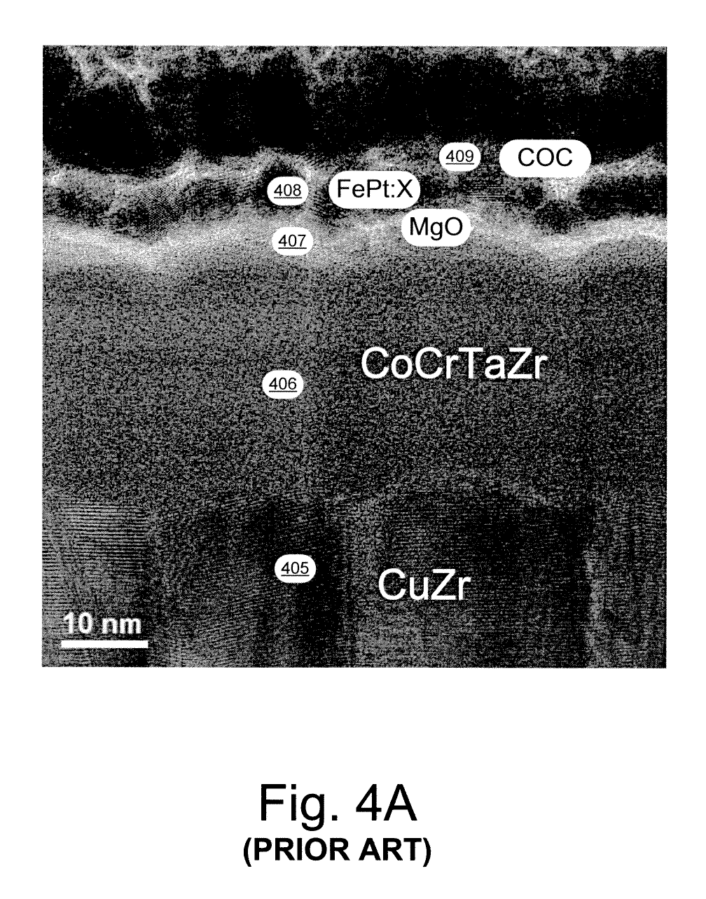

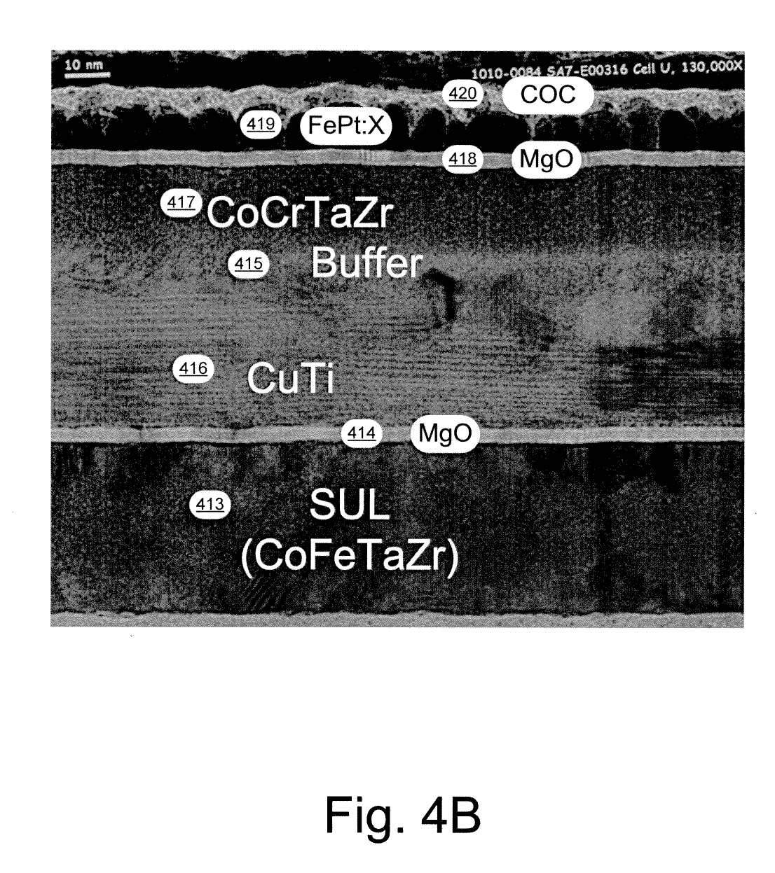

FIG. 2 illustrates an embodiment of a HAMR medium at various steps of the method described with respect to FIG. 1. In the illustrated embodiment, a SUL layer 206 is applied to a substrate 205. In some embodiments, the substrate may comprise a glass substrate. However a NiP coated aluminum substrate or other substrate may be used if capable of withstanding the processing temperature used in crystallizing the CuTi. An adhesion layer 207, such as a layer of MgO is applied on the SUL. The amorphous heatsink layer 208 is deposited on the adhesion layer 207. An amorphous interlayer 209 is then deposited on the amorphous heatsink layer 208. In some embodiments, where the amorphous interlayer 209 is on the CuTi layer of the heatsink layer 208, a region of interdiffusion, or “buffer” layer may be formed between the interlayer 209 and heatsink layer 208. This buffer layer remains amorphous even after heating, improving the surface smoothness of the resultant media. A buffer layer formed between a CoCrTaZr and a CuTi is illustrated and described further below with respect to FIG. 4B.

As described above, after a heating step, the amorphous heatsink layer 208 crystallizes to form a crystalline heatsink layer 210. In embodiments having a buffer layer between a CuTi layer of the heatsink and the interlayer 209, the buffer layer remains amorphous after heating.

As described above with respect to FIG. 1, while the underlayer formed of the interlayer 209, heatsink 210, adhesion layer 207, and SUL 206, are still hot, a hard magnetic layer 211 and capping layer 212 are applied, to ensure proper crystallization of the hard magnetic layer 211. After cooling, an overcoat layer 213 may be applied on the capping layer 212, and a lubricant layer 214 may be applied on the overcoat layer 213.

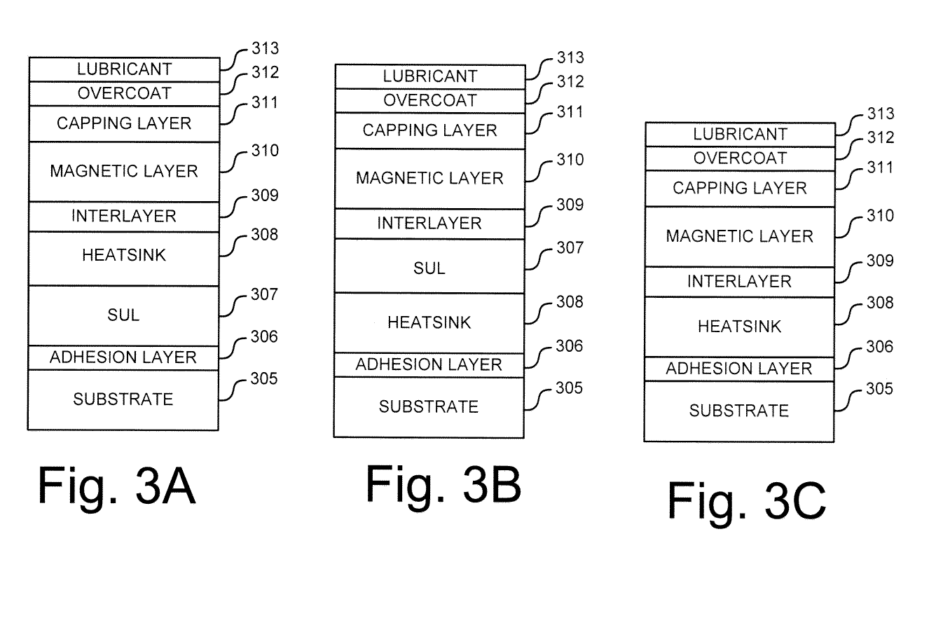

FIGS. 3A-C illustrate various layer configurations for HAMR recording media implemented in accordance with embodiments of the invention. FIG. 3A illustrates an embodiment as described with respect to FIGS. 1 and 2. A adhesion layer 306 is deposited on a substrate 305. A SUL 307 is deposited on the adhesion layer 306. A heatsink layer 308 is deposited on SUL 307. In some embodiments, the heatsink layer comprises CuₓTi₁₀₀₋ₓ where x is between 55 and 49 at. %. In various embodiments, the crystal structure of the CuTi eliminates or reduces the relationship between heatsink thickness and underlayer roughness. In these embodiments, the CuTi layer may be between 0 and 200 nm, and more particularly between 10 and 50 nm. Additionally, in some embodiment a thin crystal seed layer may be deposited between the heatsink 308 and SUL 307. In further embodiments, a thin layer of a material, such as CuZr, may be deposited between the heatsink 308 and SUL 307 to prevent interdiffusion between the two layers. An amorphous interlayer 309 is deposited on the heatsink 308. Magnetic layer 301 is deposited on the interlayer 309. Capping layer 311 is deposited on the magnetic layer 301. Finally, overcoat 312 and lubricant 313 are deposited over the capping layer 311. The embodiment of FIG. 3B is similar to that of FIG. 3A, except that the SUL 307 is deposited on the heatsink 308, and the interlayer 309 is deposited on the SUL 307. FIG. 3C illustrates an embodiment without a SUL 307, for HAMR media that do not require soft magnetic underlayers.

FIGS. 4A and 4B are images comparing the roughness of a prior art heatsink to a heatsink implemented in accordance with an embodiment of the invention. FIG. 4A illustrates a prior art heatsink 405 composed of CuZr, with between 0.3-5 at. % Zr and a balance of Cu. The illustrated CuZr heatsink 405 has a (111) texture and shows a rough surface, resulting in a roughened interlayer 406 of CoCrTaZr, seed layer 407 of MgO, hard magnetic recording layer 408 of FePt:X, and carbon overcoat 409.

FIG. 4B illustrates the lowered roughness from a heatsink 416 comprising CuTi. In this medium, a SUL 413 comprising CoFeTaZr was coated with a seed layer 414 of MgO. A crystallized CuTi layer 416 was formed on the seed layer 414 and is significantly smoother than the CuZr heatsink layer 405. Additionally, a buffer layer 415 comprising an amorphous interdiffusion layer between the interlayer 417 and the crystal CuTi layer 416 further smoothes the surface of the heatsink. Accordingly, the interlayer 417, seed layer 418, magnetic layer 419, and overcoat 420 are significantly smoother than the counterparts in the medium illustrated in FIG. 4A. In various experiments, underlayer roughness at the MgO layer was reduced from ˜7 Å to ˜2.5 Å.

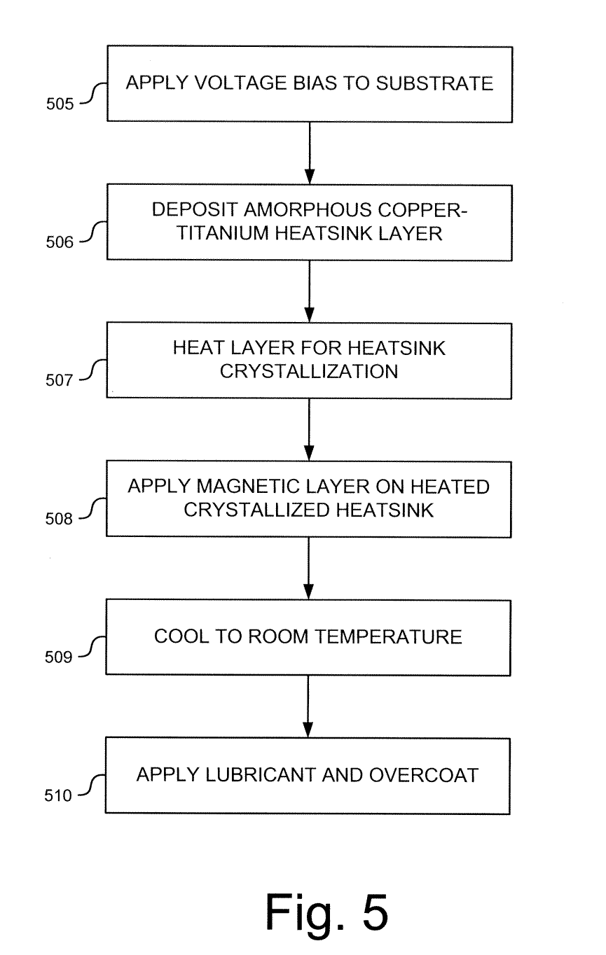

Application of a negative voltage bias during the CuTl sputtering process effects the structure, and smoothness, of the eventual crystalline CuTi layer. FIG. 5 illustrates a method of manufacturing a HAMR media utilizing a negative voltage bias during sputtering. In step 505, a voltage bias is applied to the substrate and base layer that will receive the CuTi. In various embodiments, biases between 0V and −500V may be employed. With a bias applied to the base layer, a layer of amorphous CuTi is applied to the base layer in step 506. Any other amorphous underlayer, such as an interlayer, is also applied during this step. As described above with respect to FIG. 1, the deposition may comprise sputtering the amorphous CuTi onto the base layer. In step 507, the voltage bias is removed and the amorphous CuTi heatsink layer is heated to crystallize the amorphous CuTi. In accordance with the method described with respect to FIG. 1, in step 508 the magnetic layer and any capping are applied to the heated underlayer, which includes the crystallized CuTi layer. In step 509, the medium is cooled to room temperature and, in step 510, overcoat and lubricant layers are applied.

In some embodiments, the application of a voltage bias during the sputtering process may increase the atomic mobility at the surface of the coating. As the mobility increases, the atoms are freer to assume a smoother surface configuration. Additionally, the application of a voltage bias may assist the CuTi in forming varying crystal structure. The crystallized CuTi may assume crystal structures in the tetragonal crystal system, space group P4/nmm, with space group numbers 129 or 123. The application of a voltage bias may impact which crystal structure is assumed by the CuTi. In particular, when an unbiased amorphous layer is heated, the CuTi may form the space group number 129 crystal and when a biased amorphous layer is heated, the CuTi may form the space group number 123 crystal. One or both of these effects may further improve the roughness in HAMR media. For example, a media comprising (from lowest layer to highest layer): 1) a substrate; 2) 40 nm CoFeTaZr; 3) 4 nm MgO; 4) 40 nm CuTi; 5) 20 nm CoTaZr; 6) 4 nm MgO; 7) 5 nm FePt—C30; 8) 5 nm FePt—C40; and 9) 2 nm of CVD and flash C, was investigated for determining the effect of a voltage bias. In the experiment, normalized 1 um Ra full stack (V3 L cell process) roughness tests were conducted. A 0V bias resulted in a full stack surface roughness of 8.56 Å, a 150V bias resulted in a full stack surface roughness of 8.40 Å, and a 250V bias resulted in a full stack surface roughness of 8.16 Å.

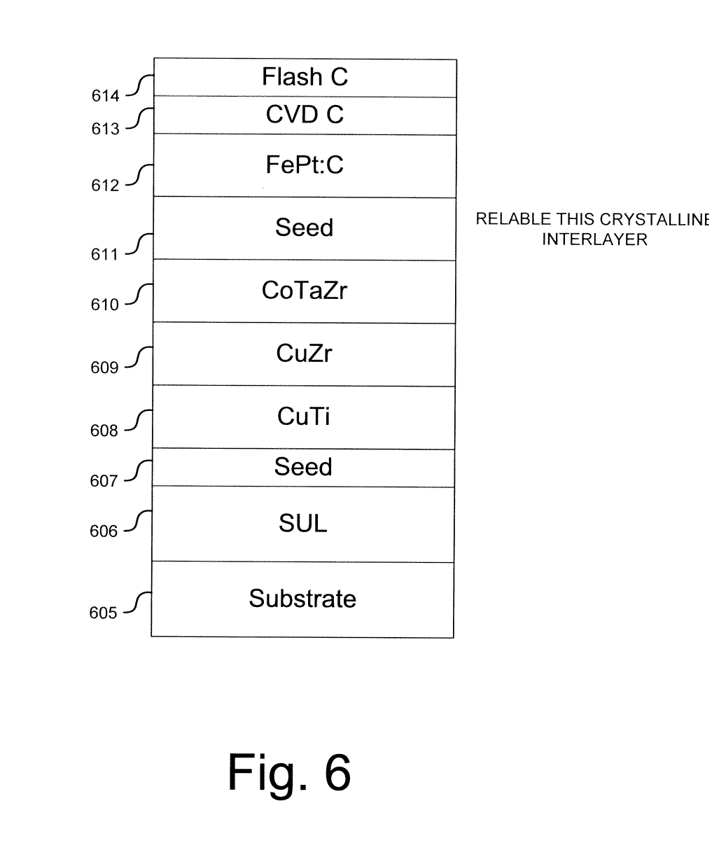

In some embodiments, a heatsink layer for a HAMR media may comprise a dual layer heatsink comprising a layer of CuZr and a layer of CuTi. FIG. 6 illustrates one such HAMR medium. In the illustrated medium, a SUL 606, such as a CoFeTaZr layer, is deposited over a substrate 605. A seed layer 607, such as a layer of MgO, is deposited over the SUL 606.

A first heatsink layer of CuTi 608 is deposited over the seed layer 607. In some embodiments, the CuTi comprises CuₓTi₁₀₀₋ₓ where x is between 55 and 49 at. %. In various embodiments, the CuTi layer may be between 0 and 200 nm, and more particularly between 10 and 50 nm. In some embodiments, a thin layer of CuZr may be deposited between the CuTi layer 608 and the SUL 606 to prevent interdiffusion between the two layers.

A second heatsink layer 609 of CuZr is deposited over the CuTi layer 608. In various embodiments, the CuZr layer comprises CuZrₓ, where x is between 0.3 and 5 at. % and may be between 0 and 50 nm, or more particularly, between 5 and 40 nm.

An interlayer 610, such as CoTaZr, is deposited over the CuZr layer 609. A second interlayer, such as seed layer 611, which may comprise a layer of Ta, Cr, RuAl, NiAl, TiN, CrMo, CrTi, CrVa, CrT, CrTa, CrRu, or MgO, is deposited over the interlayer 610. The seed layer 611 forms a crystal seed layer for a hard magnetic recording layer 612, such as one or more layers of FePt:C, is deposited over the seed layer 611. A lubricant 614 and overcoat 614 are deposited over the hard magnetic recording layer 612.

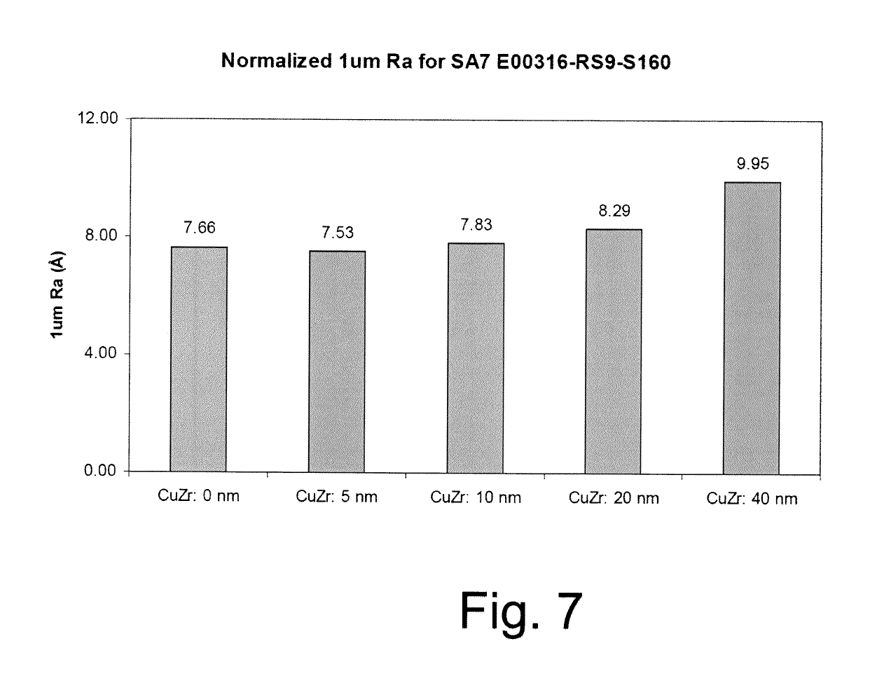

In embodiments employing a dual layer CuZr and CuTi heatsink, the CuTir reduces the (111) texture of the upper CuZr layer, decreasing the roughness of the CuZr layer that would otherwise be present. FIG. 7 illustrates experimental results for various dual layer heatsinks. The media stack for these experiments was (from bottom to top): 1) a glass substrate; 2) a layer of CoFeTaZr; 3) 4 nm of MgO; 4) 40 nm of CuTi; 5)×nm of CuZr; 6) 20 nm of CoTaZr; 7) a layer of MgO; 8) 10 nm of FePt:C 30/20; 9) a CVD C overcoat; and 10) a flash C lubricant. The graph of FIG. 7 illustrates the roughness results for the indicated values of x. The use of a layer of CuZr in a dual heatsink effects the thermal barrier resistance. In experiments, a media having 200 nm CuTi had a Rₜₕ=11×10⁻⁹ m²K/W, the introduction of 10 nm of CuZr to the media reduced Rₜₕ to 3×10⁹ m²K/W. In various applications, the thermal resistance and heat conductivity parameters of the media may be adjusted in the design phase by varying the thicknesses of the CuZr and CuTi layers.

In the foregoing specification, embodiments of the invention have been described with reference to specific exemplary features thereof. It will, however, be evident that various modifications and changes may be made thereto without departing from the broader spirit and scope of the invention as set forth in the appended claims. The specification and figures are, accordingly, to be regarded in an illustrative rather than a restrictive sense.

What is claimed is:

1. A method of manufacturing a magnetic recording medium, the method comprising:
applying a layer of amorphous CuTi on a base layer disposed over a magnetic recording medium substrate;
heating the layer of amorphous CuTi to a temperature sufficient to cause the layer of amorphous CuTi to form a layer of crystallized CuTi; and
cooling the layer of crystallized CuTi.

2. The method of claim 1, further comprising applying a layer of CuZr on the layer of amorphous CuTi.

3. The method of claim 2, wherein the layer of CuZr comprises CuZrₓ, where x is between 0.3 and 5 at. %, and is between 0 nm and 50 nm thick.

4. The method of claim 1, further comprising applying a negative voltage bias between 0V and −500V to the base layer while depositing the layer of amorphous CuTi.

5. The method of claim 1, further comprising applying a hard magnetic recording layer over the layer of crystallized CuTi prior to the step of cooling the layer of crystallized CuTi.

6. The method of claim 5, further comprising applying a soft magnetic underlayer over the layer of crystallized CuTi prior to the step of applying the hard magnetic recording layer; and wherein the step of applying the hard magnetic recording layer further comprises applying the hard magnetic recording layer over the soft magnetic underlayer.

7. The method of claim 1, wherein the base layer comprises a soft magnetic underlayer.

8. The method of claim 1, wherein the base layer comprises an adhesion layer.

9. The method of claim 8, wherein the adhesion layer comprises CrTa, CrTi, AlTa, AlTi, NiNb, or NiTa.

10. The method of claim 1, wherein the base layer comprises a crystal seed layer.

11. The method of claim 10, wherein the crystal seed layer comprises Ta, Cr, RuAl, NiAl, TiN, CrMo, CrTi, CrVa, CrT, CrTa, CrRu, or MgO.

12. The method of claim 1, further comprising applying an amorphous interlayer over the layer of amorphous CuTi.

13. The method of claim 12, wherein the amorphous interlayer comprises CrTa, CoCrTaZr, CoTaZr or CrTi.

14. The method of claim 12, further comprising forming an amorphous interdiffusion layer between the layer of amorphous CuTi and the amorphous interlayer.

15. The method of claim 12, further comprising applying a second interlayer over the amorphous interlayer, the second interlayer comprising Ta, Cr, RuAl, NiAl, TiN, CrMo, CrTi, CrVa, CrT, CrTa, CrRu, or MgO, and forming a crystal seed layer for the hard magnetic layer.

16. The method of claim 1, wherein the CuTi comprises between 55 at. % and 49 at. % Cu and between 45 at. % and 51 at. % Ti.

17. The method of claim 1, wherein the temperature sufficient to cause the layer of amorphous CuTi to form a layer of crystallized CuTi is between 350° C. and 650° C.

18. The method of claim 1, wherein the layer of crystallized CuTi is between 10 nm and 200 nm thick.

19. The method of claim 18, wherein the layer of crystallized CuTi is between 30 nm and 50 nm thick.

20. The method of claim 1, wherein the step of cooling the layer of crystallized CuTi comprises cooling the layer of crystallized CuTi from the temperature sufficient to cause the layer of amorphous CuTi to form a layer of crystallized CuTi to room temperature at a cooling rate between 10° C./sec and 200° C./sec.

21. A magnetic recording medium, comprising:
a substrate;
a heatsink layer comprising a layer of crystallized CuTi; and
a hard magnetic recording layer.

22. The magnetic recording medium of claim 21, wherein the heatsink layer further comprises a layer of CuZr.

23. The magnetic recording medium of claim 22, wherein the layer of CuZr comprises CuZrₓ, where x is between 0.3 and 5 at. %, and is between 0 nm and 50 nm thick.

24. The magnetic recording medium of claim 21, wherein the layer of crystallized CuTi has a crystal structure in the tetragonal crystal system with space group P4/mmm and space group number 123.

25. The magnetic recording medium of claim 21, wherein the layer of crystallized CuTi has a crystal structure in the tetragonal crystal system with space group P4/mmm and space group number 129.

26. The magnetic recording medium of claim 21, wherein the CuTi comprises between 55 at. % and 49 at. % Cu and between 45 at. % and 51 at. % Ti.

27. The magnetic recording medium of claim 21, wherein the layer of crystallized CuTi is between 10 nm and 200 nm.

28. The magnetic recording medium of claim 27, wherein the layer of crystallized CuTi is between 30 nm and 50 nm.

29. The magnetic recording medium of claim 21, further comprising a soft magnetic underlayer under the heatsink layer.

30. The magnetic recording medium of claim 21, further comprising an adhesion layer under the heatsink layer.

31. The magnetic recording medium of claim 30, wherein the adhesion layer comprises CrTa, CrTi, AlTa, AlTi, NiNb, or NiTa.

32. The magnetic recording medium of claim 21, further comprising a crystal seed layer under the heatsink layer.

33. The magnetic recording medium of claim 32, wherein the crystal seed layer comprises Ta, Cr, RuAl, NiAl, TiN, CrMo, CrTi, CrVa, CrT, CrTa, CrRu, or MgO.

34. The magnetic recording medium of claim 21, further comprising an amorphous interlayer deposited over the layer of CuTi.

35. The magnetic recording medium of claim 34, wherein the amorphous interlayer comprises CrTa, CoCrTaZr, CoTaZr or CrTi.

36. The magnetic recording medium of claim 34, further comprising a second interlayer over the amorphous interlayer, the second interlayer comprising Ta, Cr, RuAl, NiAl, TiN, CrMo, CrTi, CrVa, CrT, CrTa, CrRu, or MgO, and forming a crystal seed layer for the hard magnetic layer.

37. The magnetic recording medium of claim 32, further comprising an amorphous interdiffusion layer between the layer of CuTi and the amorphous interlayer.
